(19) United States
(12) Patent Application Publication
(10) Pub. No.: US 2026/0023000 A1
(43) Pub. Date: Jan. 22, 2026

(54) BENDING TEST APPARATUS AND BENDING TEST METHOD USING THE SAME

(71) Applicant: SAMSUNG DISPLAY CO., LTD., Yongin-si (KR)

(72) Inventor: GABTAE KIM, Yongin-si (KR)

(21) Appl. No.: 19/227,103

(22) Filed: Jun. 3, 2025

(30) Foreign Application Priority Data
Jul. 19, 2024 (KR) 10-2024-0095752

(51) Int. Cl. G01N 3/20; G01N 3/04; G01N 3/06

(52) U.S. Cl. CPC G01N 3/20; G01N 3/04; G01N 3/068

(57) ABSTRACT

A bending test apparatus and a bending test method are disclosed. A bending test apparatus includes a first chuck including a first support surface, a second chuck spaced apart from a first end of the first chuck, the second chuck including a second support surface, and a rotator configured to rotate the second chuck with respect to the first chuck. The first support surface includes a first flat support surface, and a first inclined support surface coupled to the first flat support surface. The first inclined support surface is between the first flat support surface and the first end of the first chuck, and a first acute angle is defined between the first inclined support surface and the first flat support surface.

### CROSS-REFERENCE TO RELATED APPLICATION

The present application claims priority to and the benefit of Korean Patent Application No. 10-2024-0095752, filed on Jul. 19, 2024 in the Korean Intellectual Property Office, the entire disclosure of which is hereby incorporated by reference.

### BACKGROUND

### 1. Field

Aspects of embodiments of the present disclosure herein relate to a bending test apparatus and a bending test method using the same.

### 2. Description of Related Art

Electronic apparatuses, such as smartphones, digital cameras, laptop computers, navigation units, and smart televisions, which provide an image to a user, include a display apparatus for displaying the image. The display apparatus generates an image and provides the generated image to the user through a display screen.

Recently, with the technological development for the display apparatus, various types of display apparatuses are being developed. For example, a variety of flexible display apparatuses, which are deformable, foldable, or rollable into curved shapes, are being developed. The flexible display apparatuses are easy to carry and may enhance a user's convenience. As a type of flexible display apparatuses, there is a foldable display apparatus of which the display is foldable.

### SUMMARY

According to an aspect of one or more embodiments of the present disclosure, a bending test apparatus capable of performing tests on various types of bending, and a bending test method using the same, are provided.

According to an aspect of one or more embodiments of the present disclosure, a bending test apparatus capable of performing tests on displays that may be folded more than twice, and a bending test method using the same, are provided.

According to an aspect of one or more embodiments of the present disclosure, a bending test apparatus that may adjust a distance between chucks according to a shape and/or a size of a display, and a bending test method using the same, are provided.

According to one or more embodiments, a bending test apparatus includes: a first chuck including a first support surface; a second chuck spaced apart from a first end of the first chuck, the second chuck including a second support surface; and a rotator configured to rotate the second chuck with respect to the first chuck, wherein the first support surface includes: a first flat support surface; and a first inclined support surface coupled to the first flat support surface, wherein the first inclined support surface is between the first flat support surface and the first end of the first chuck, and a first acute angle is defined between the first inclined support surface and the first flat support surface.

According to one or more embodiments, a bending test apparatus includes: a first chuck including a first support surface; a second chuck spaced apart from a first end of the first chuck, the second chuck including a second support surface; a third chuck spaced apart from a first end of the second chuck, the third chuck including a third support surface; a first rotator configured to rotate the second chuck with respect to the first chuck; a second rotator configured to rotate the third chuck with respect to the second chuck; and a camera (e.g., a high-speed camera) configured to photograph the first chuck, the second chuck, and the third chuck, wherein the second chuck is between the first chuck and the third chuck.

According to one or more embodiments, a bending test method includes: placing a display apparatus on a bending test apparatus; and driving the bending test apparatus to bend the display apparatus, wherein the bending test apparatus includes: a first chuck including a first support surface; and a second chuck spaced apart from a first end of the first chuck, the second chuck including a second support surface, wherein the bending of the display apparatus comprises rotating the second chuck with respect to the first chuck until the first support surface faces the second support surface, wherein, when the first support surface faces the second support surface, a first distance between the first support surface and the second support surface on the first end of the first chuck is greater than a second distance between the first support surface and the second support surface on a second end of the first chuck.

### BRIEF DESCRIPTION OF THE DRAWINGS

The accompanying drawings are included to provide a further understanding of the present disclosure, and are incorporated in and constitute a part of this specification. The drawings illustrate some embodiments of the present disclosure and, together with the description, are provided to explain principles of the present disclosure. In the drawings:

FIG. 1 is a cross-sectional view of a bending test apparatus according to an embodiment of the present disclosure;

FIG. 2 is an enlarged cross-sectional view of a portion of the bending test apparatus according to an embodiment of the present disclosure;

FIG. 3 is an enlarged cross-sectional view of a first chuck of the bending test apparatus according to an embodiment of the present disclosure;

FIG. 4 is an enlarged cross-sectional view of a second chuck of the bending test apparatus according to an embodiment of the present disclosure;

FIG. 5 is an enlarged cross-sectional view of a portion of the bending test apparatus according to an embodiment of the present disclosure;

FIG. 6 is a flowchart showing a bending test method according to an embodiment of the present disclosure;

FIGS. 7 and 8 are views showing a bending test method according to the flowchart of FIG. 6;

FIG. 9 is a cross-sectional view of a bending test method according to an embodiment of the present disclosure;

FIGS. 10 and 11 are cross-sectional views of a bending test method according to an embodiment of the present disclosure;

FIGS. 12 and 13 are cross-sectional views of a bending test method according to an embodiment of the present disclosure;

FIGS. 14 and 15 are cross-sectional views of a bending test method according to an embodiment of the present disclosure;

FIGS. 16 and 17 are cross-sectional views of a bending test method according to an embodiment of the present disclosure;

FIGS. 18 and 19 are cross-sectional views of a bending test method according to an embodiment of the present disclosure; and

FIG. 20 is a cross-sectional view of a bending test method according to an embodiment of the present disclosure.

### DETAILED DESCRIPTION

In this specification, it is to be understood that when one component, region, layer, or portion is referred to as being “on,” “connected to,” or “coupled to” another component, it may be directly disposed/connected/coupled on/to the one component, or one or more intervening third components may also be present.

Like numbers refer to like elements throughout. Also, in the figures, the thickness, ratio, and/or dimensions of components may be exaggerated for clarity of illustration. The term “and/or” includes any and all combinations of one or more of the associated listed items.

Although the terms “first,” “second,” etc. may be used herein to describe various elements, these elements are not to be limited by these terms. The terms are used to distinguish one component from other components. For example, a first element referred to as a first element in an embodiment can be referred to as a second element in another embodiment without departing from the scope of the appended claims. The singular forms include the plural forms as well, unless the context clearly indicates otherwise.

Also, “under,” “below,” “above,” “upper,” and the like may be used for explaining relation association of components illustrated in the drawings. These terms are used as a spatially relative concept and are described based on the directions indicated in the drawings.

It is to be understood that the terms “include” or “comprise,” when used in this specification, specify the presence of stated features, integers, steps, operations, elements, components, or a combination thereof, but do not preclude the presence or addition of one or more other features, integers, steps, operations, elements, components, or combinations thereof.

Unless otherwise defined, all terms including technical and scientific terms used herein have the same meaning as commonly understood by one of ordinary skill in the art to which the present disclosure belongs. In addition, terms such as those defined in commonly used dictionaries should be interpreted as having meanings consistent with their meanings in the context of the relevant technology and, unless explicitly defined, are not to be interpreted in an overly idealistic or overly formal sense.

Herein, a bending test apparatus and a bending test method using the same according to one or more embodiments of the present disclosure will be described with reference to the drawings.

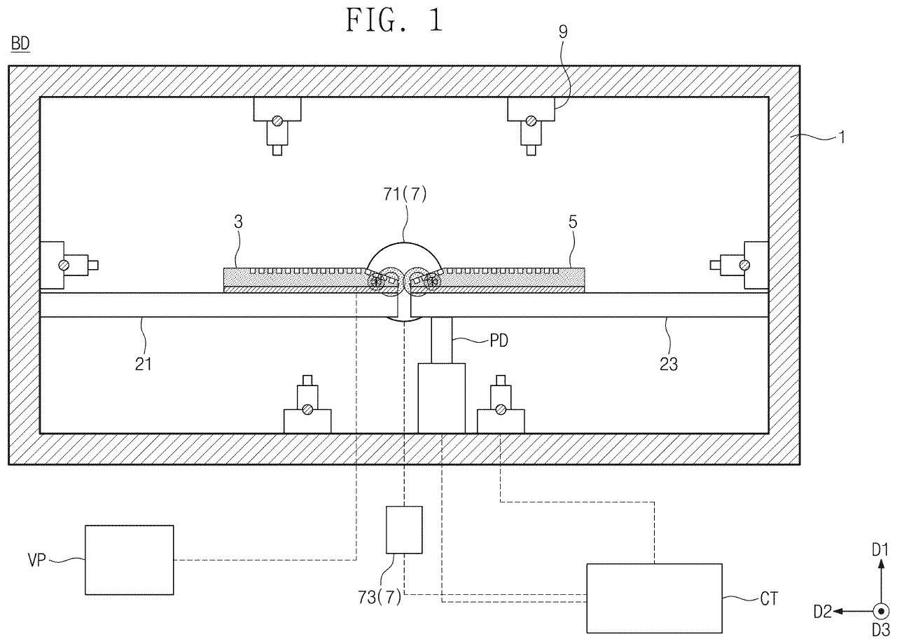

FIG. 1 is a cross-sectional view of a bending test apparatus according to an embodiment of the present disclosure.

Herein, D1 may be referred to as a first direction, D2 crossing the first direction D1 may be referred to as a second direction, and D3 crossing both the first direction D1 and the second direction D2 may be referred to as a third direction. The first direction D1 may be referred to as a vertical direction. Also, each of the second direction D2 and the third direction D3 may be referred to as a horizontal direction.

Referring to FIG. 1, a bending test apparatus BD according to an embodiment is shown. The bending test apparatus BD may be an apparatus that evaluates a bending performance of a display apparatus. More particularly, the bending test apparatus BD may evaluate the bending performance of a flexible display apparatus. For example, the bending test apparatus BD may identify a deformation shape and whether the flexible display apparatus is damaged when the flexible display apparatus bends to evaluate the bending strength of the flexible display apparatus. In an embodiment, the bending test apparatus BD may include a housing 1, a first chuck 3, a second chuck 5, a first stage 21, a second stage 23, a rotation device, or rotator, 7, a camera (e.g., a high-speed camera) 9, a vacuum pump VP, a parallel driving device, or driver, PD, and a control part, or controller, CT.

The housing 1 may support the first chuck 3, the second chuck 5, the first stage 21, the second stage 23, the rotation device 7, and the high-speed camera 9. A bending evaluation for the display apparatus may be conducted within the housing 1. In an embodiment, an internal space of the housing 1 may be separated from an external space, but is not limited thereto.

The first chuck 3 may support a portion of the display apparatus. That is, a first surface of a portion of the display apparatus may be in contact with the first chuck 3. The first chuck 3 may fix the display apparatus. In an embodiment, the first chuck 3 may include a vacuum chuck, for example. In this case, a vacuum pump VP may be connected to the first chuck 3. Due to the vacuum pressure provided by the vacuum pump VP, the display apparatus may be fixed in an adsorbed state on the first chuck 3. However, the present disclosure is not limited thereto, and the first chuck 3 may fix the display apparatus in other ways. For example, the first chuck 3 may fix the display apparatus using an electrostatic force. That is, the first chuck 3 may include an electrostatic chuck (ESC). In this case, the first chuck 3 may include a static electrode. In another embodiment, the first chuck 3 may have both a function of a vacuum chuck and an electrostatic chuck. In other words, the first chuck 3 may include a vacuum electrostatic chuck. In this case, the first chuck 3 may fix the display apparatus using vacuum pressure and an electrostatic force. In another embodiment, the first chuck 3 may include a clamp chuck and/or a magnetic chuck. However, for convenience, the following description and illustration will be based on the first chuck 3 including a vacuum chuck. The first chuck 3 will be described later in further detail.

The second chuck 5 may be spaced apart from a first end of the first chuck 1. The second chuck 5 may be spaced apart from the first end of the first chuck 1 in a direction opposite to the second direction D2. The second chuck 5 may support another portion of the display apparatus. In other words, a first surface of the another portion of the display apparatus may be in contact with the second chuck 5. The second chuck 5 may be movable with respect to the first chuck 3. The second chuck 5 may be rotatable with respect to the first chuck 3. The second chuck 5 may be connected to the rotation device 7. This will be described later in further detail. The second chuck 5 may fix the display apparatus. For this, the second chuck 5 may include a vacuum chuck, for example. In this case, the vacuum pump VP may be connected to the second chuck 5. Due to a vacuum pressure provided by the vacuum pump VP, the display apparatus may be fixed in an adsorbed state on the second chuck 5. However, the present disclosure is not limited thereto, and the second chuck 5 may fix the display apparatus in another manner. For example, the second chuck 5 may fix the display apparatus using an electrostatic force. That is, the second chuck 5 may include an electrostatic chuck (ESC). In this case, the second chuck 5 may include an electrostatic electrode. In another embodiment, the second chuck 5 may have both the vacuum chuck function and the electrostatic chuck function. That is, the second chuck 5 may include a vacuum electrostatic chuck. In this case, the second chuck 5 may fix the display apparatus using vacuum pressure and electrostatic force. In another embodiment, the second chuck 5 may include a clamp chuck and/or a magnetic chuck, etc. However, for convenience, the following description and illustration will be based on the second chuck 5 including a vacuum chuck. The second chuck 5 will be described later in further detail.

The first stage 21 may support the first chuck 3. The first chuck 3 may be disposed on a top surface of the first stage 21. The first stage 21 may be supported by the housing 1. For example, the first stage 21 may be fixedly coupled to the housing 1.

The second stage 23 may support the second chuck 5. The second chuck 5 may be disposed on a top surface of the second stage 23. The second stage 23 may be supported by the housing 1. For example, the second stage 23 may be movable with respect to the housing 1. In an embodiment, the second stage 23 may move parallel in the first direction D1, the second direction D2, and/or the third direction D3 by the parallel driving device PD. The second stage 23 may be connected to the parallel driving device PD. Thus, a relative distance between the second chuck 5 and the first chuck 3 may be adjusted.

In an embodiment, the rotation device 7 may rotate the second chuck 5 with respect to the first chuck 3. In an embodiment, the rotation device 7 may rotate the first chuck 3 with respect to the second chuck 5. In an embodiment, the rotation device 7 may rotate each of the first chuck 3 and the second chuck 5 with respect to each other. The rotation device 7 may include a rotation guiding device 71 and a rotation driving device 73. A first end of the rotation guiding device 71 may be coupled to the first chuck 3. A second end of the rotation guiding device 71 may be connected to the second chuck 5. The rotation guiding device 71 may include, for example, a gear assembly, but is not limited thereto. The rotation driving device 73 may provide rotational driving force to the rotation guiding device 71. For this, the rotation driving device 73 may include an electric motor and/or a hydraulic actuator, for example, but is not limited thereto.

The high-speed camera 9 may be spaced apart from each of the first chuck 3 and the second chuck 5. For example, the high-speed camera 9 may be fixedly coupled to the housing 1. The high-speed camera 9 may photograph the display apparatus disposed on the first chuck 3 and the second chuck 5. The high-speed camera 9 may rapidly photograph a bending state of the display apparatus. The high-speed camera 9 may rotate such that a point at which the high-speed camera 9 photographs changes. In an embodiment, a plurality of high-speed cameras 9 may be provided. The plurality of high-speed cameras 9 may be spaced apart from each other. However, herein, the high-speed camera 9 will be described in singular form for convenience. The high-speed camera 9 will be described later in further detail.

The vacuum pump VP may be connected to each of the first chuck 3 and the second chuck 5. The vacuum pump VP may provide vacuum pressure to each of the first chuck 3 and the second chuck 5. As a result, the display apparatus on the first chuck 3 and the second chuck 5 may be fixed to each of the first chuck 3 and the second chuck 5.

The parallel driving device PD may be connected to the second stage 23. The parallel driving device PD may move the second stage 23 in the first direction D1, the second direction D2, and/or the third direction D3. The parallel driving device PD may include an electric motor and/or a hydraulic actuator, but is not limited thereto.

The control part CT may control the rotation driving device 73, the parallel driving device PD, and the high-speed camera 9. Information about the display apparatus, which is photographed by the high-speed camera 9 may be analyzed by the control part CT.

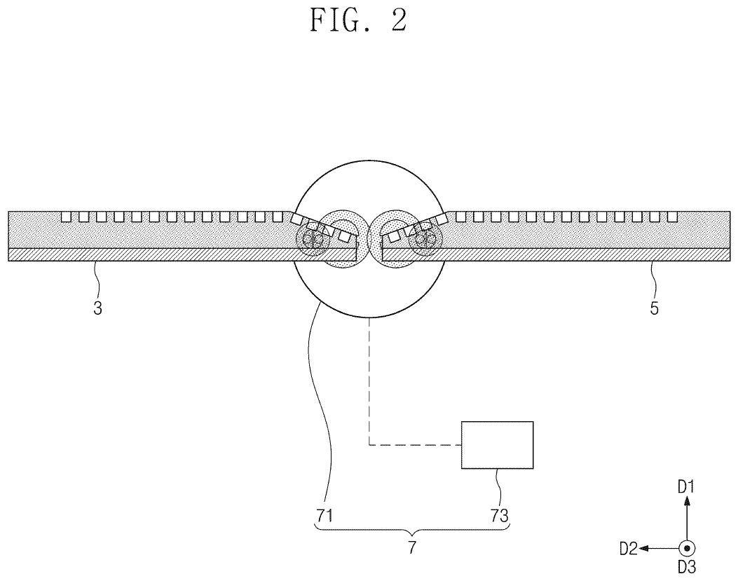

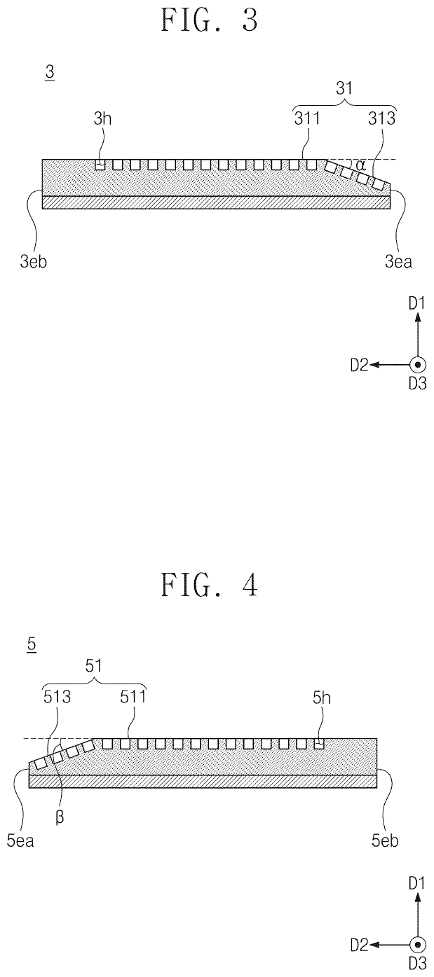

FIG. 2 is an enlarged cross-sectional view of a portion of the bending test apparatus according to an embodiment of the present disclosure; FIG. 3 is an enlarged cross-sectional view of the first chuck of the bending test device according to an embodiment of the present disclosure; and FIG. 4 is an enlarged cross-sectional view of the second chuck of the bending test device according to an embodiment of the present disclosure.

Referring to FIG. 2 and FIG. 3, the first chuck 3 may have a first support surface 31. The first support surface 31 may be a top surface of the first chuck 1. The first support surface 31 may include a first flat support surface 311 and a first inclined support surface 313. In a state in which the first chuck 3 and the second chuck 5 are unfolded, the first flat support surface 311 may be perpendicular to the first direction D1. The first inclined support surface 313 may be disposed between a first end 3ea of the first chuck 3 and the first flat support surface 311. The first inclined support surface 313 may be coupled or connected to the first flat support surface 311. The first inclined support surface 313 may be coupled or connected to the first end 3ea of the first chuck 3. The first flat support surface 311 may be coupled or connected to a second end 3eb of the first chuck 3. The first inclined support surface 313 may be inclined with respect to the first flat support surface 311. The first inclined support surface 313 and the first flat support surface 311 may define an acute angle therebetween. An angle between the first inclined support surface 313 and the first flat support surface 311 may be referred to as a first acute angle α. The first acute angle α may be, for example, about 3° to 75°, but is not limited thereto.

The first chuck 3 may provide a first vacuum hole 3h. The first vacuum hole 3h may be defined in the first support surface 31. The first vacuum hole 3h may be connected to the vacuum pump VP (see FIG. 1). A plurality of first vacuum holes 3h may be provided. A portion of the plurality of first vacuum holes 3h may be defined in the first flat support surface 311. Another portion of the plurality of first vacuum holes 3h may be defined in the first inclined support surface 313. However, for convenience, the first vacuum hole 3h will be described in singular form.

Referring to FIGS. 2 and 4, the second chuck 5 may have a second support surface 51. The second support surface 51 may be a top surface of the second chuck 5. The second support surface 51 may include a second flat support surface 511 and a second inclined support surface 513. In a state in which the first chuck 3 and the second chuck 5 are unfolded, the second flat support surface 511 may be perpendicular to the first direction D1. The second inclined support surface 513 may be disposed between a first end 5ea of the second chuck 5 and the second flat support surface 511. The second inclined support surface 513 may be coupled or connected to the second flat support surface 511. The second inclined support surface 513 may be coupled or connected to the first end 5ea of the second chuck 5. The second flat support surface 511 may be coupled or connected to a second end 5eb of the second chuck 5. The second inclined support surface 513 may be inclined with respect to the second flat support surface 511. The second inclined support surface 513 and the second flat support surface 511 may define an acute angle therebetween. An angle between the second inclined support surface 513 and the second flat support surface 531 may be referred to as a second acute angle β. The second acute angle β may be, for example, about 3° to 75°, but is not limited thereto. In an embodiment, the second acute angle β may be the same or similar to the first acute angle α, but is not limited thereto.

The second chuck 5 may provide a second vacuum hole 5h. The second vacuum hole 5h may be defined in the second support surface 51. The second vacuum hole 5h may be connected to the vacuum pump VP (see FIG. 1). A plurality of second vacuum holes 5h may be provided. A portion of the plurality of second vacuum holes 5h may be defined in the second flat support surface 511. Another portion of the plurality of second vacuum holes 5h may be disposed on the second inclined support surface 513. However, for convenience, the second vacuum hole 5h will be described in singular form.

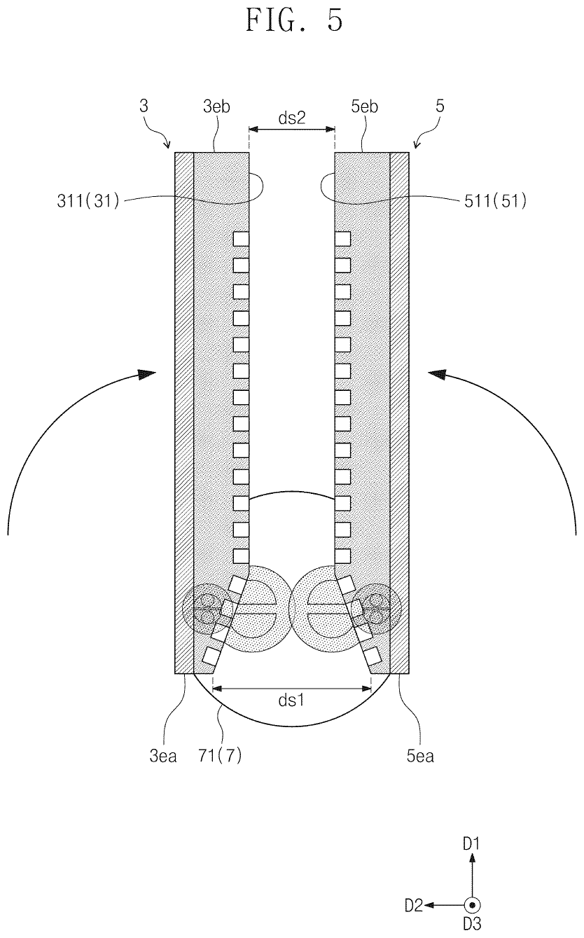

FIG. 5 is an enlarged cross-sectional view of the bending test apparatus according to an embodiment of the present disclosure.

Referring to FIG. 5, each of the first chuck 3 and the second chuck 5 may be rotated by the rotation device 7. In an embodiment, the first chuck 3 may be rotated clockwise by the rotation device 7. In an embodiment, the second chuck 5 may rotate counterclockwise by the rotation device 7. Accordingly, the first support surface 31 and the second support surface 51 may face each other. For example, the first flat support surface 311 and the second flat support surface 511 may face each other in parallel. When the first supporting surface 31 and the second supporting surface 51 face each other, a distance between the first end 3ea of the first chuck 3 and the first and second support surfaces 31 and 51 may be referred to as a first distance ds1. When the first support surface 31 and the second support surface 51 face each other, a distance between the second end 3eb of the first support surface 31 and the first and second support surfaces 31 and 51 may be referred to as a second distance ds2. The second distance ds2 may be less than the first distance ds1. That is, the first distance ds1 may be greater than the second distance ds2.

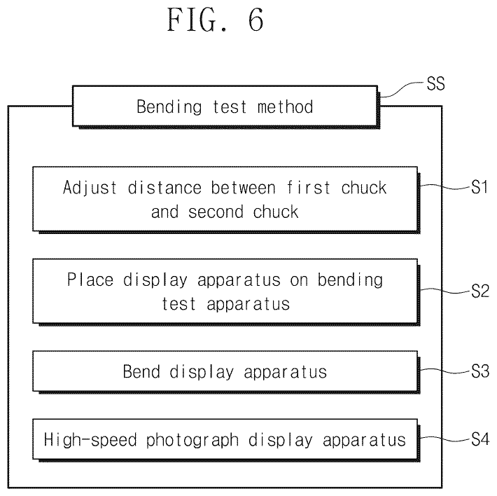

FIG. 6 is a flowchart showing a bending test method according to an embodiment of the present disclosure.

Referring to FIG. 6, a bending test method SS according to an embodiment is shown. The bending test method SS may be a method for evaluating the bending of a display apparatus using the bending test apparatus BD described with reference to FIGS. 1 to 5. The bending test method SS may include adjusting a distance between the first and second chucks S1, placing the display apparatus on the bending test apparatus S2, bending the display apparatus S3, and photographing (e.g., high-speed photographing) the display apparatus S4.

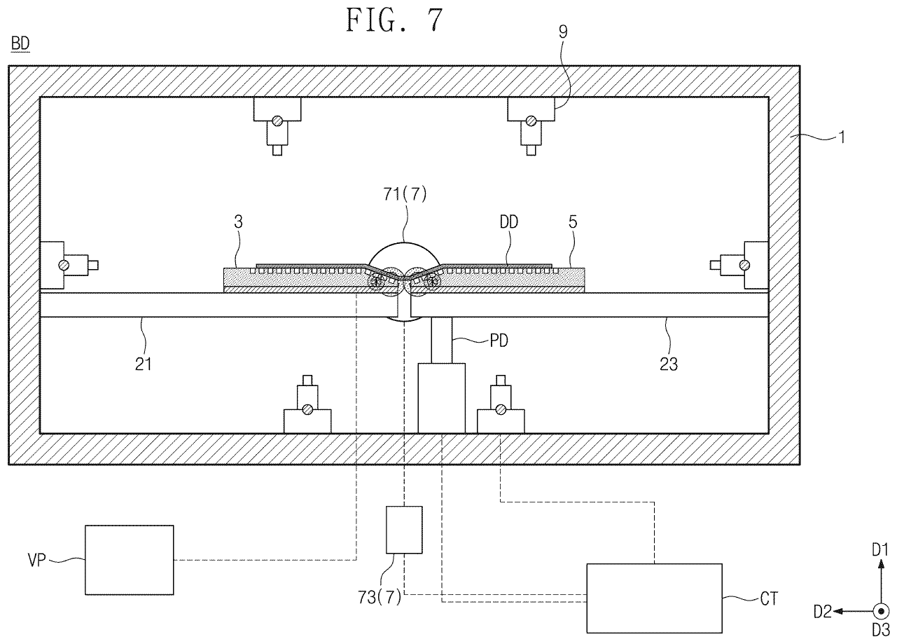

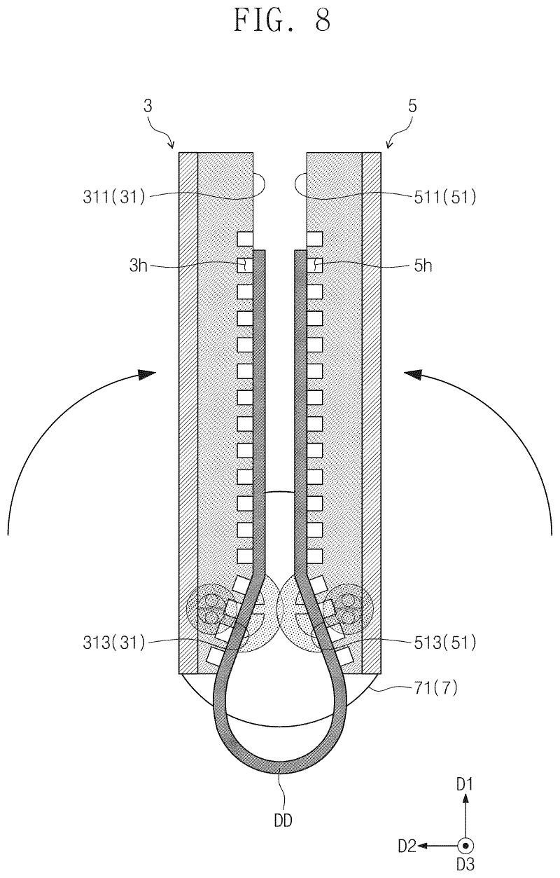

Herein, the bending test method SS of FIG. 6 will be described in further detail with reference to FIGS. 7 to 8.

FIGS. 7 and 8 are views showing a bending test method according to the flowchart of FIG. 6.

Referring to FIG. 7 and FIG. 6, the adjusting of the distance between the first chuck and the second chuck S1 may include moving the second chuck 5 in parallel using a parallel driving device PD. Accordingly, a distance between the first chuck 3 and the second chuck 5 may vary. The distance between the first chuck 3 and the second chuck 5 may be determined according to the display apparatus to be tested. In an embodiment, in a state in which the first chuck 3 and the second chuck 5 are unfolded by the rotation device 7, the first support surface 31 and the second support surface 51 may be parallel.

The placing of the display apparatus on the bending test apparatus S2 may include placing the display apparatus DD on the first support surface 31 and the second support surface 51. The display apparatus DD may be fixed on the first chuck 3 and the second chuck 5 by vacuum pressure provided by the vacuum pump VP.

Referring to FIG. 8 and FIG. 6, the bending of the display apparatus S3 may include rotating the second chuck 5 and/or the first chuck 3 by the rotation device 7 until the first support surface 31 and the second support surface 51 face each other. Accordingly, the display apparatus DD may be folded. In an embodiment, by the first inclined support surface 313 and the second inclined support surface 513, a lower end of the display apparatus DD may have a dumbbell shape.

The high-speed photographing of the display apparatus S4 may include high-speed photographing of the bent display apparatus DD by the high-speed camera 9. Information about the display apparatus DD photographed by the high-speed camera 9 may be transmitted to the control part CT (see FIG. 1). The control part CT may analyze the deformation characteristics of the display apparatus DD when the display apparatus DD is bent in a dumbbell shape.

According to the bending test apparatus and bending test method using the same according to embodiments of the present disclosure, it is possible to perform tests on various types of bending. For example, the display apparatus may be guided to have a dumbbell shape when it folds by using the first inclined support surface and/or the second inclined support surface. By simulating the deformed shape of the display apparatus used in actual smartphones and/or tablets, accurate test results may be obtained.

According to the bending test apparatus and the bending test method using the same according to embodiments of the present disclosure, the distance between the first chuck and the second chuck may be adjusted according to the shape and/or size of the display apparatus. Therefore, it is possible to perform tests suitable for various display apparatuses.

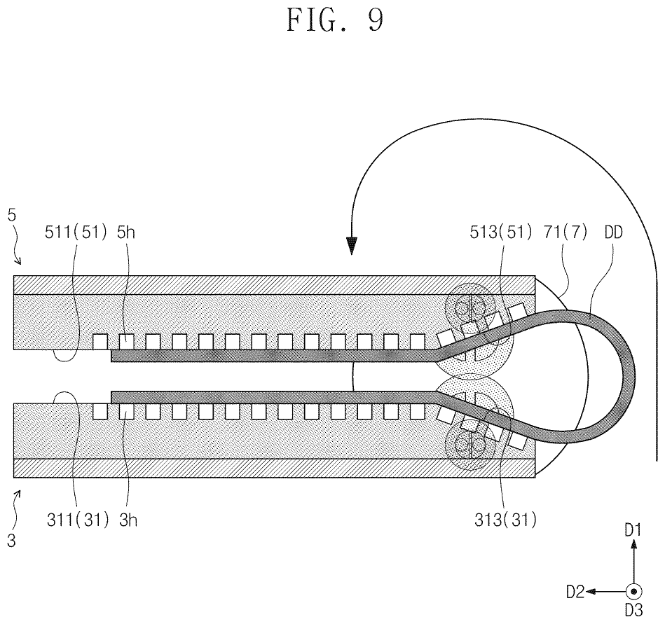

FIG. 9 is a cross-sectional view of a bending test method according to an embodiment of the present disclosure.

Herein, descriptions the same or similar to those described with reference to FIGS. 1 to 8 may be omitted.

Referring to FIG. 9, the first chuck 3 does not rotate, but only the second chuck 5 may rotate by the rotation device 7. The second chuck 5 may rotate until the second support surface 51 faces the second support surface 31.

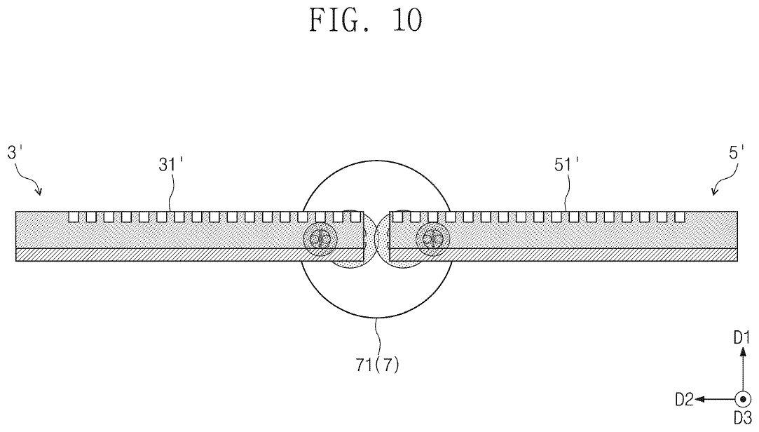

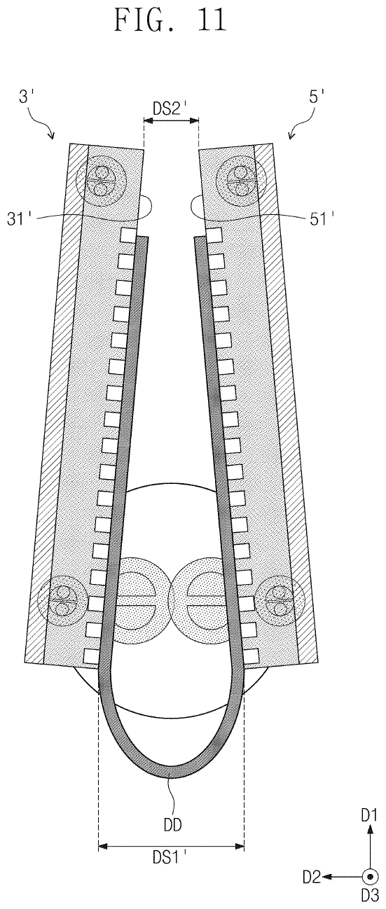

FIGS. 10 and 11 are cross-sectional views of a bending test method according to an embodiment of the present disclosure.

Herein, descriptions the same or similar to those described with reference to FIGS. 1 to 9 may be omitted.

Referring to FIG. 10, a first chuck 3′ and a second chuck 5′ may be provided. The first chuck 3′ may include a first support surface 31′. The first support surface 31′ may extend from a first end of the first chuck 3′ to a second end of the first chuck 3′. The first support surface 31′ may be one plane. The second chuck 5′ may include a second support surface 51′. The second support surface 51′ may extend from a first end of the second chuck 5′ to a second end of the second chuck 5′. The second support surface 51′ may be one plane.

Referring to FIG. 11, the first chuck 3′ and/or the second chuck 5′ rotate by the rotation device such that the first support surface 31′ and the second support surface 51′ may face each other. When the first support surface 31′ and the second support surface 51′ face each other, a first distance DS1′ between the first support surface 31′ and the second support surface 51′ at the first end of the first chuck 3′ may be greater than a second distance DS2′ between the first support surface 31′ and the second support surface 51′ at the second end of the first chuck 3′. Accordingly, the display apparatus DD may have a droplet shape.

According to the bending test apparatus and bending test method using the same according to embodiments of the present disclosure, it is possible to perform tests on various types of bending. For example, the first support surface and/or the second support surface may be used to guide the display apparatus to have a droplet shape when it folds. By simulating the deformed shape of the display apparatus used in actual smartphones and/or tablets, accurate test results may be obtained.

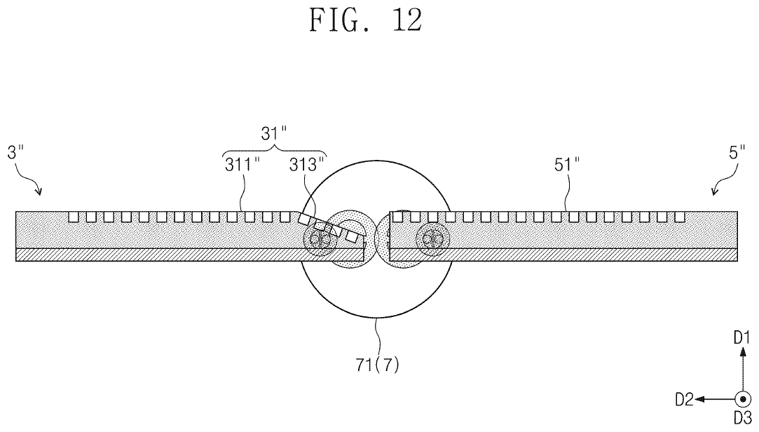

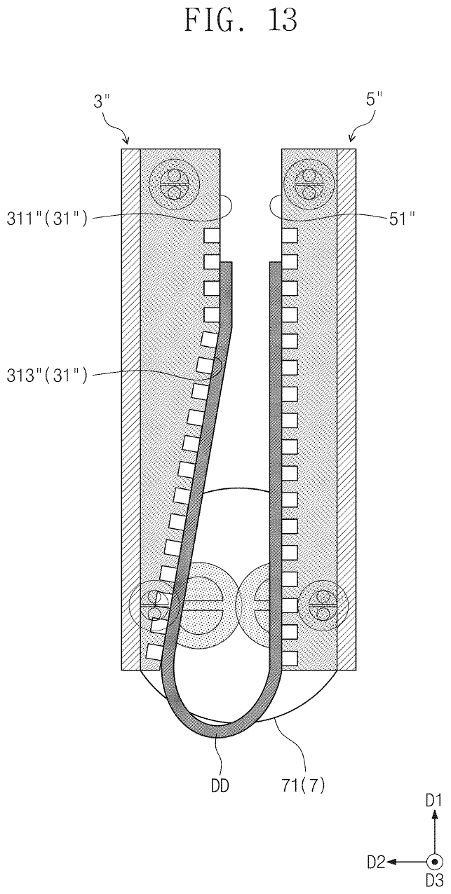

FIGS. 12 and 13 are cross-sectional views of a bending test method according to an embodiment of the present disclosure.

Herein, descriptions the same or similar to those described with reference to FIGS. 1 to 11 may be omitted.

Referring to FIG. 12, a first chuck 3″ may include a first support surface 31″. The first support surface 31″ may include a first flat support surface 311″ and a first inclined support surface 313″. The second chuck 5″ may include a second support surface 51″. The second support surface 51″ may be one plane.

Referring to FIG. 13, the first chuck 3″ and/or the second chuck 5″ rotate by the rotation device such that the first support surface 31″ and the second support surface 51″ may face each other. Accordingly, the display apparatus DD may have a half-dumbbell shape.

According to the bending test apparatus and bending test method using the same according to embodiments of the present disclosure, it is possible to perform tests on various types of bending. For example, using the first support surface and/or the second support surface, the display apparatus may be guided to have a semi-dumbbell shape when folded. By simulating the deformed shape of the display apparatus used in actual smartphones and/or tablets, accurate test results may be obtained.

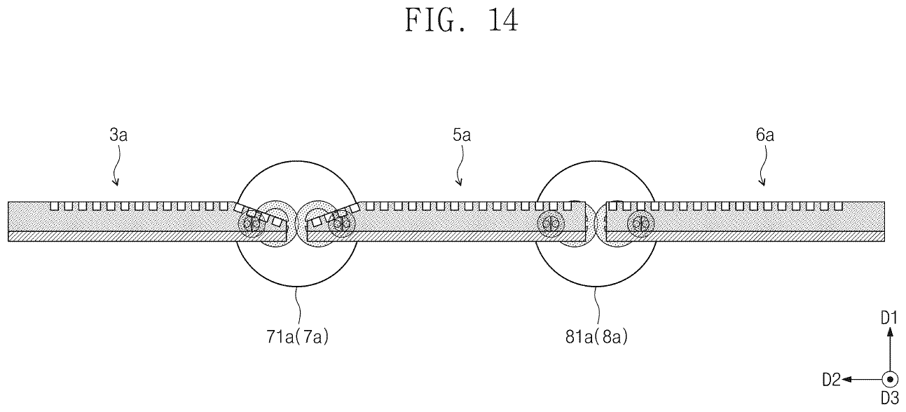

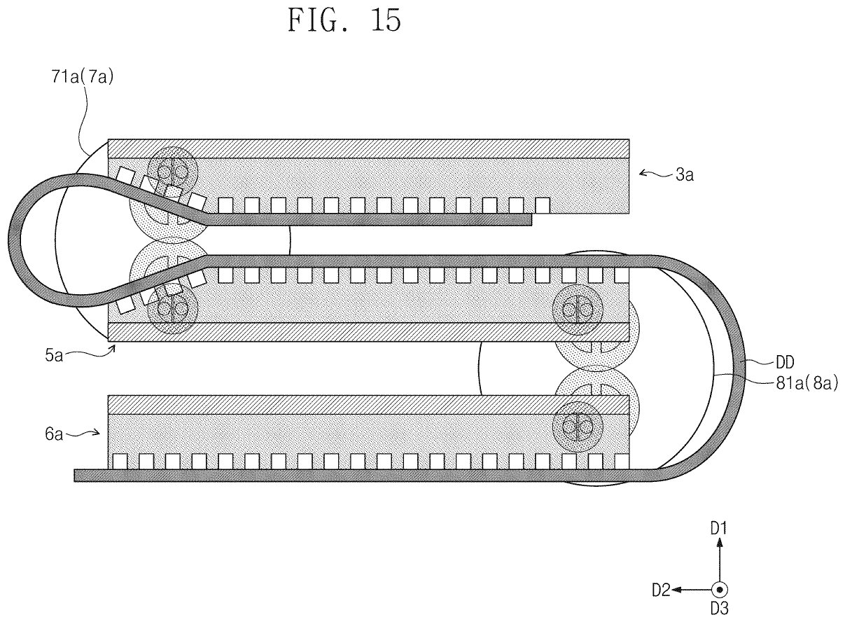

FIGS. 14 and 15 are cross-sectional views of a bending test method according to an embodiment of the present disclosure.

Herein, descriptions the same or similar to those described with reference to FIGS. 1 to 13 may be omitted.

Referring to FIG. 14, a first chuck 3a, a second chuck 5a, a third chuck 6a, a first rotation device, or first rotator, 7a, and a second rotation device, or second rotator, 8a may be provided. The second chuck 5a may be spaced apart from a first end of the first chuck 3a. The third chuck 6a may be spaced apart from a first end of the second chuck 5a. The third chuck 6a may have a third support surface (not shown). The second chuck 5a may be disposed between the first chuck 3a and the third chuck 6a. The first rotation device 7a may include a first rotation guiding device, or first rotation guide, 71a and a first rotation driving device, or first rotation driver (not shown). A first end of the first rotation guiding device 71a may be coupled to the first chuck 3a. A second end of the first rotation guiding device 71a may be connected to the second chuck 5a. The first rotation driving device may provide a rotational driving force to the first rotation guiding device 71a. The second rotation device 8a may include a second rotation guiding device, or second rotation guide, 81a and a second rotation driving device, or second rotation driver (not shown). A first end of the second rotation guiding device 81a may be coupled to the second chuck 5a. A second end of the second rotation guiding device 81a may be coupled to the third chuck 7a. The second rotation driving device may provide a rotational driving force to the second rotation guiding device 81a. In an embodiment, in a state in which the first chuck 3a and the second chuck 5a are unfolded by the first rotation device 7a, and in which the second chuck 5a and the third chuck 7a are unfolded by the second rotation device 8a, the first support surface, the second support surface, and the third support plane may be disposed on a same plane. In an embodiment, areas of the first support surface, the second support surface, and the third support surface may be the same, but are not limited thereto.

Referring to FIG. 15, the first rotation device 7a may rotate the second chuck 5a with respect to the first chuck 3a. The second rotation device 8a may rotate the third chuck 6a with respect to the second chuck 5a. In a state in which the first chuck 3a and the second chuck 5a are folded by the first rotation device 7a, the first chuck 3a may be disposed on the second chuck 5a. In a state in which the second chuck 5a and the third chuck 6a are folded by the second rotation device 8a, the second chuck 5a may be disposed on the third chuck 6a.

According to the bending test apparatus and bending test method using the same according to embodiments of the present disclosure, it is possible to perform tests on various types of bending. For example, tests may be conducted on display apparatuses that fold more than twice. By simulating the deformed shape of the display apparatus used in actual smartphones and/or tablets, accurate test results may be obtained.

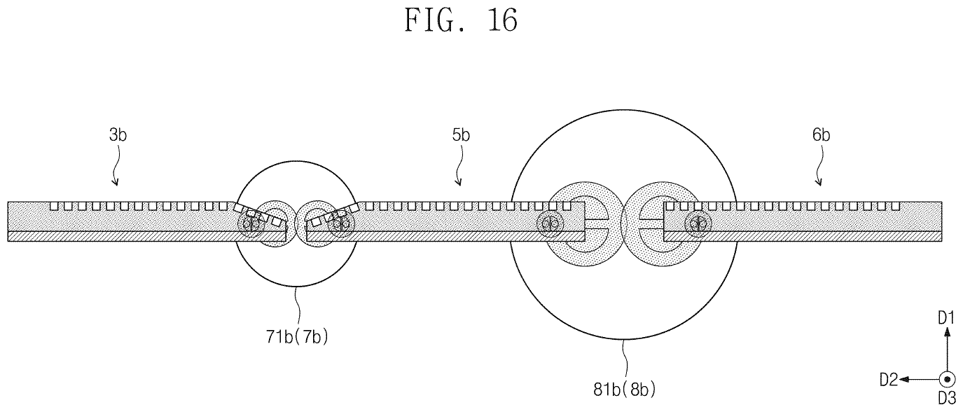

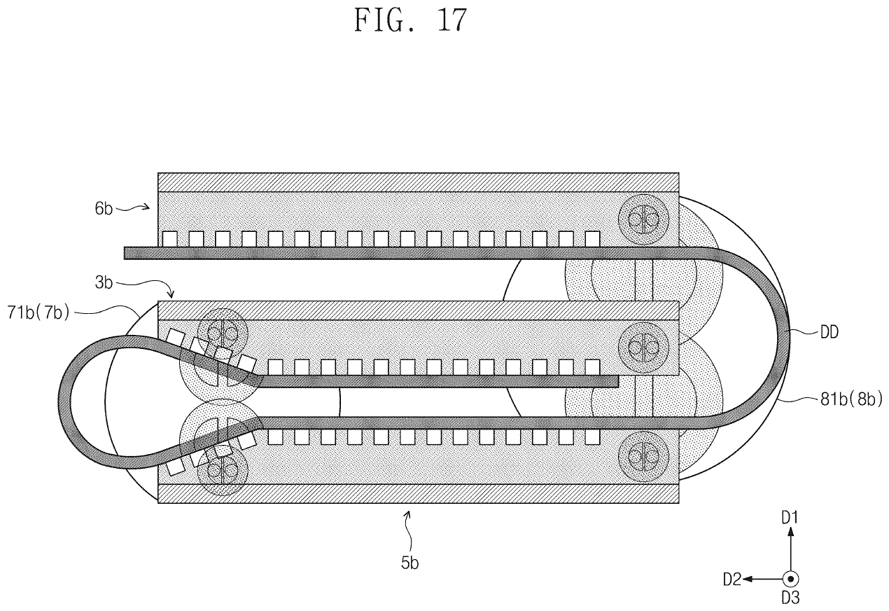

FIGS. 16 and 17 are cross-sectional views of a bending test method according to an embodiment of the present disclosure.

Herein, descriptions the same or similar to those described with reference to FIGS. 1 to 15 may be omitted.

Referring to FIGS. 16 and 17, a first rotation device 7b may rotate a second chuck 5b with respect to a first chuck 3b. A second rotation device 8b may rotate a third chuck 6b with respect to the second chuck 5b. In a state in which the first chuck 3b and the second chuck 5b are folded by the first rotation device 7b, the first chuck 3b may be disposed on the second chuck 5b. In a state in which the second chuck 5b and the third chuck 6b are folded by the second rotation device 8b, the third chuck 6b may be disposed on the second chuck 5b.

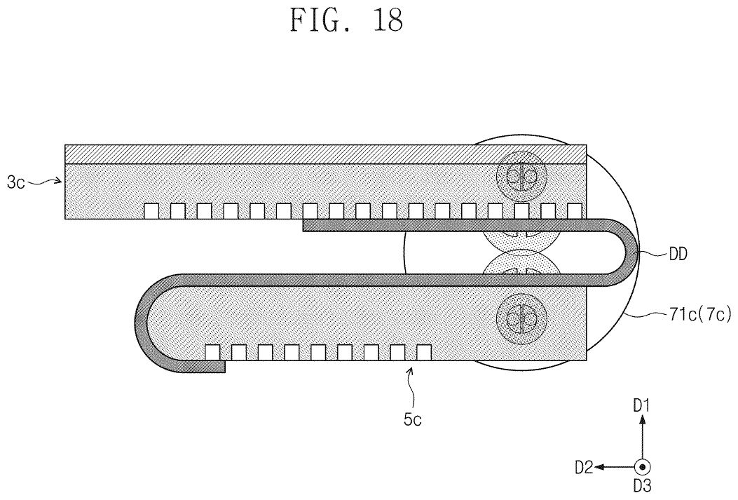

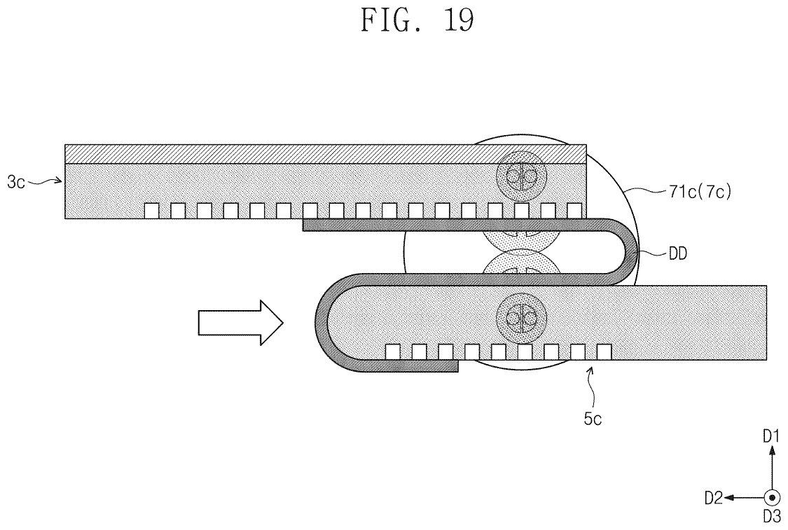

FIGS. 18 and 19 are cross-sectional views of a bending test method according to an embodiment of the present disclosure.

Herein, descriptions the same or similar to those described with reference to FIGS. 1 to 17 may be omitted.

Referring to FIGS. 18 and 19, a first chuck 3c, a second chuck 5c, and a rotation device 7c may be provided. In a state in which the first chuck 3c and the second chuck 5c are folded by the rotation device 7c, the second chuck 5c may horizontally move in parallel. Accordingly, the display apparatus DD may slide.

According to the bending test apparatus and bending test method using the same according to embodiments of the present disclosure, it is possible to perform tests on various types of bending. For example, a test may be performed on a sliding display apparatus. By simulating the deformed shape of the display apparatus used in actual smartphones and/or tablets, accurate test results may be obtained.

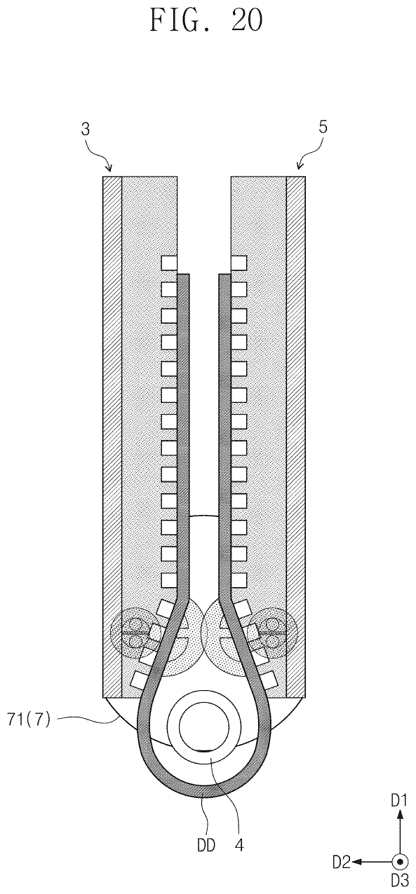

FIG. 20 is a cross-sectional view of a bending test method according to an embodiment of the present disclosure.

Herein, descriptions the same or similar to those described with reference to FIGS. 1 to 19 may be omitted.

Referring to FIG. 20, a pressing roller 4 may be provided between the first chuck 3 and the second chuck 5. In an embodiment, the pressing roller 4 may include a pressure sensor. Therefore, in a state in which the first and second chucks 3 and 5 are folded, pressure may be applied to a bent portion of the display apparatus DD. The pressure sensor of the pressing roller 4 may measure the pressure applied to the display apparatus DD.

According to the bending test apparatus and bending test method using the same according to embodiments of the present disclosure, it is possible to perform tests on various types of bending. For example, it is possible to perform a test for a situation where foreign substances are lodged in the display apparatus. By simulating the deformed shape of the display apparatus used in actual smartphones and/or tablets, accurate test results may be obtained.

According to the bending test apparatus and the bending test method using the same according to one or more embodiments of the present disclosure, it is possible to perform the test on various types of bending.

According to the bending test apparatus and the bending test method using the same according to one or more embodiments of the present disclosure, it is possible to perform the test on a display that folds more than twice.

According to the bending test apparatus and the bending test method using the same according to one or more embodiments of the present disclosure, it is possible to adjust the distance between the chucks in response to the shape and/or size of the display.

Although described with reference to some embodiments of the present disclosure, it is to be understood that various changes and modifications of the present disclosure may be made by one skilled in the art or one having ordinary knowledge in the art without departing from the spirit and technical field of the present disclosure as herein claimed. Hence, the technical scope of the inventive concept is to be determined by the claims, and is not to be limited by the foregoing description.

What is claimed is:

1. A bending test apparatus comprising:
a first chuck comprising a first support surface;
a second chuck spaced apart from a first end of the first chuck, the second chuck comprising a second support surface; and
a rotator configured to rotate the second chuck with respect to the first chuck,
wherein the first support surface comprises:
a first flat support surface; and
a first inclined support surface coupled to the first flat support surface,
wherein the first inclined support surface is between the first flat support surface and the first end of the first chuck, and
a first acute angle is defined between the first inclined support surface and the first flat support surface.

2. The bending test apparatus of claim 1, wherein each of the first chuck and the second chuck comprises a vacuum chuck, and
each of the first inclined support surface and the second support surface comprises a plurality of vacuum holes.

3. The bending test apparatus of claim 2, further comprising a vacuum pump connected to each of the first chuck and the second chuck.

4. The bending test apparatus of claim 1, wherein each of the first chuck and the second chuck comprises an electrostatic chuck.

5. The bending test apparatus of claim 1, further comprising a camera spaced apart from each of the first chuck and the second chuck.

6. The bending test apparatus of claim 1, wherein, in a state in which the first chuck and the second chuck are unfolded by the rotator, the second support surface is parallel to the first flat support surface.

7. The bending test apparatus of claim 1, wherein the second support surface comprises:
a second flat support surface; and
a second inclined support surface coupled to the second flat support surface,
wherein the second inclined support surface is between the second flat support surface and the first end of the first chuck,
wherein a second acute angle is defined between the second inclined support surface and the second flat support surface, and
wherein the second acute angle is the same as the first acute angle.

8. The bending test apparatus of claim 1, wherein the rotator comprises:
a rotation guide comprising a first end coupled to the first chuck and a second end coupled to the second chuck; and
a rotation driver configured to provide a rotational driving force to the rotation guide.

9. The bending test apparatus of claim 1, further comprising a parallel driving device configured to parallelly move the first chuck and the second chuck.

10. A bending test apparatus comprising:
a first chuck comprising a first support surface;
a second chuck spaced apart from a first end of the first chuck, the second chuck comprising a second support surface;
a third chuck spaced apart from a first end of the second chuck, the third chuck comprising a third support surface;
a first rotator configured to rotate the second chuck with respect to the first chuck;
a second rotator configured to rotate the third chuck with respect to the second chuck; and
a camera configured to photograph the first chuck, the second chuck, and the third chuck,
wherein the second chuck is between the first chuck and the third chuck.

11. The bending test apparatus of claim 10, wherein the first rotator comprises:
a first rotation guide comprising a first end coupled to the first chuck, and a second end coupled to the second chuck; and
a first rotation driver configured to provide a first rotational driving force to the first rotation guide,
wherein the second rotator comprises:
a second rotation guide comprising a first end coupled to the second chuck, and a second end coupled to the third chuck; and
a second rotation driver configured to provide a second rotational driving force to the second rotation guide.

12. The bending test apparatus of claim 10, wherein, in a state in which the first and second chucks are unfolded by the first rotation device, and the second and third chucks are unfolded by the second rotation device, the first support surface, the second support surface, and the third support surface are on a same plane.

13. The bending test apparatus of claim 10, wherein surfaces areas of the first support surface, the second support surface, and the third support surface are the same.

14. The bending test apparatus of claim 10, wherein, in a state in which the first chuck and the second chuck are folded by the first rotator, the first chuck is on the second chuck, and, in a state in which the second chuck and the third chuck are folded by the second rotator, the third chuck is below the second chuck.

15. The bending test apparatus of claim 10, wherein, in a state in which the first chuck and the second chuck are folded by the first rotator, the first chuck is on the second chuck, and, in a state in which the second chuck and the third chuck are folded by the second rotator, the third chuck is on the first chuck.

16. A bending test method comprising:
placing a display apparatus on a bending test apparatus; and
driving the bending test apparatus to bend the display apparatus,
wherein the bending test apparatus comprises:
a first chuck comprising a first support surface; and
a second chuck spaced apart from a first end of the first chuck, the second chuck comprising a second support surface,
wherein the bending of the display apparatus comprises rotating the second chuck with respect to the first chuck until the first support surface faces the second support surface,
wherein, when the first support surface faces the second support surface, a first distance between the first support surface and the second support surface on the first end of the first chuck is greater than a second distance between the first support surface and the second support surface on a second end of the first chuck.

17. The bending test method of claim 16, wherein the first support surface comprises:
a first flat support surface; and
a first inclined support surface coupled to the first flat support surface,
wherein the first inclined support surface is between the first flat support surface and the first end of the first chuck,
wherein a first acute angle is defined between the first inclined support surface and the first flat support surface.

18. The bending test method of claim 16, further comprising photographing the display apparatus when the bending test apparatus is driven to bend the display apparatus.

19. The bending test method of claim 16, wherein the placing of the display apparatus on the bending test apparatus comprises:
placing the display apparatus on the first support surface;
placing the display apparatus on the second support surface; and
fixing the display apparatus using the first and second chucks.

20. The bending test method of claim 16, further comprising adjusting a distance between the first and second chucks before the placing of the display apparatus on the bending test apparatus.
